(19) United States
(12) Patent Application Publication
(10) Pub. No.: US 2026/0088302 A1
(43) Pub. Date: Mar. 26, 2026

(54) MULTIPHASE SEI-ENGINEERED POLYMERIC INTERLAYER AND SULFIDE ALL-SOLID-STATE LITHIUM METAL BATTERIES COMPRISING THE SAME

(71) Applicant: UIF (University Industry Foundation), Yonsei University, Seoul (KR)

(72) Inventors: Sang-Young LEE, Seoul (KR); Yoon Seok JUNG, Seoul (KR); Kyeong Seok OH, Seoul (KR); Yong Bae SONG, Seoul (KR); Se Jung OH, Seoul (KR); Bo Yeong JANG, Seoul (KR)

(73) Assignee: UIF (University Industry Foundation), Yonsei University, Seoul (KR)

(21) Appl. No.: 19/335,549

(22) Filed: Sep. 22, 2025

(30) Foreign Application Priority Data
Sep. 23, 2024 (KR) 10-2024-0128223
Jul. 28, 2025 (KR) 10-2025-0102333

(51) Int. Cl. H01M 4/62; H01M 10/052; H01M 10/0562

(52) U.S. Cl. CPC H01M 4/628; H01M 10/052; H01M 10/0562; H01M 2300/0068

(57) ABSTRACT

The present invention relates to a multiphase SEI-engineered polymeric interlayer (MSEPI) for solving the chronic interfacial instability and lithium dendrite formation problems between a lithium (Li) metal anode and a sulfide solid electrolyte (SSE) in high energy density sulfide all-solid-state lithium metal batteries (ASLMBs), etc., and a battery comprising the same. All-solid-state batteries applying MSEPI-coated lithium metal according to the present invention exhibit excellent rate characteristics and long-term cycle stability, effectively suppressing lithium dendrite growth and enabling stable and efficient lithium plating/stripping behavior, thereby greatly contributing to the realization of high-performance ASLMBs.

### CROSS-REFERENCE TO RELATED APPLICATION

This application claims priority to Korean Patent Application Nos. 10-2024-0128223 and 10-2025-0102333, filed on Sep. 23, 2024 and Jul. 28, 2025, respectively, and all the benefits accruing therefrom under 35 U.S.C. § 119, the contents of which in its entirety are herein incorporated by reference.

### TECHNICAL FIELD

The present invention relates to a multiphase SEI-engineered polymeric interlayer and sulfide all-solid-state lithium metal batteries comprising the same.

### BACKGROUND ART

High energy density all-solid-state lithium metal batteries (ASLMBs) have great potential as next-generation energy storage devices in terms of high theoretical energy density and safety. However, interfacial instability between lithium (Li) metal and sulfide solid electrolyte (SSE) remains a major unsolved technical challenge.

Lithium metal offers low density and high theoretical capacity, but during charging and discharging, lithium dendrites can form, penetrate the solid electrolyte, and cause internal short-circuits. This leads to a shortened battery life and severely compromised safety. This problem is particularly pronounced in ASLMBs where the inorganic solid electrolyte is directly in contact with lithium metal.

SSEs are gaining attention as promising solid electrolytes due to their high ionic conductivity and excellent processability, but recent studies have revealed that lithium dendrites can propagate even through the SSE matrix. This is because microstructural or mechanical heterogeneity within the electrolyte acts as initial sites for dendrite formation. Furthermore, the high stiffness of SSEs causes poor contact with the dynamically changing lithium surface during charging and discharging, forming topographically uneven interfaces.

In addition to this limitation of limited mechanical compliance, bare lithium-SSE interfaces fail to effectively mitigate electrochemical stress, hindering the formation of stable interface structures. Accordingly, the solid electrolyte interphase (SEI) layer naturally formed at the interface between the electrolyte and lithium metal plays a critical role in controlling interfacial reactions.

In conventional lithium-ion batteries (LIBs) based on liquid electrolytes, the SEI consists of a mixed layer of organic and inorganic components, but in sulfide-based ASLMBs, the naturally formed SEI (n-SEI) is predominantly composed of inorganic species such as Li2S, Li3P, and LiX (X=Cl, Br, I). Among these, Li3P has mixed ionic and electronic conductor (MIEC) properties, which can lead to parasitic reactions and irreversible lithium loss.

Furthermore, the lack of dynamic interfacial reconstruction, which is common in liquid systems, limits the adaptability and uniformity of SEI in ASLMBs over time. As a result, there is a risk of forming a spatially non-uniform and poorly protective interfacial layer. To overcome this, various interface engineering strategies have been investigated, such as LiF, Li3N, metal, metal alloy, and carbon-based interlayers.

However, interlayers composed of a single material have limitations in simultaneously satisfying the complex functions required in ASLMBs, such as chemical stability, ionic conductivity, and mechanical compliance. Due to this, flexible interface engineering strategies that can promote the integration of chemically diverse components and in-situ formation of multicomponent SEIs have recently attracted attention.

In this context, polymer electrolytes have emerged as very promising candidates for interlayer materials. Polymer electrolytes possess both flexibility and ionic conductivity, and can effectively conform to subtle irregularities on the surface. They also have the advantage of being able to mitigate volume changes that occur during lithium plating and stripping processes.

Furthermore, polymer electrolytes, through molecular tunability, can integrate functional salts or additives into their design, which can induce target-oriented interfacial reactions such as in-situ artificial SEI (a-SEI) formation.

However, the most widely used PEO (polyethylene oxide)-based polymer electrolytes rely on high molecular weight chains, which usually require solvent-assisted processing. Solvents used in such processes can cause chemical incompatibility issues with SSEs and lithium metal, thereby deteriorating interfacial stability.

### PRIOR ART DOCUMENTS

### Non-Patent Literature

1. Advanced Functional Materials 2021, 31, 2009925
2. Nanomaterials, Vol. 12, 2022.
3. Journal of Materials Chemistry A 2022, 10, 13814-13820
4. Nature Communications 2022, 13, 5431
5. Science 2017, 358, 506-510

### SUMMARY

The present invention aims to solve the chronic interfacial instability and lithium dendrite formation problems between lithium metal and sulfide solid electrolytes in high energy density all-solid-state lithium metal batteries.

The present invention aims to provide a new interface engineering strategy that overcomes the non-uniformity and limited protective function of existing naturally occurring SEI layers, and the limitations of single-material interlayers, thereby satisfying chemical stability, high ionic conductivity, and excellent mechanical compliance simultaneously.

Ultimately, the object of the present invention is to ensure stable and efficient lithium plating/stripping, thereby securing the long-term performance and stability of ASLMBs.

To solve the above problems, the present invention provides a composition for forming a polymeric interlayer comprising a monomer and a lithium-solvent complex.

The present invention also provides a polymeric interlayer obtained by solidifying the composition for forming a polymeric interlayer according to various embodiments of the present invention through polymerization or curing.

The present invention also provides a polymeric interlayer comprising a polymer or crosslinked polymer of a monomer according to various embodiments of the present invention, and a lithium-solvent complex dispersed in the polymer or crosslinked polymer.

The present invention also provides a polymeric interlayer formed by the in-situ electrochemical reaction and conversion of a polymeric interlayer solidified or cured through polymerization or crosslinking and Li metal according to various embodiments of the present invention.

The present invention also provides a battery comprising an anode, an electrolyte, and a polymeric interlayer formed at the interface between the anode and the electrolyte according to various embodiments of the present invention.

The present invention also provides a device comprising a battery according to various embodiments of the present invention.

The present invention also provides a method for manufacturing a polymeric interlayer, comprising a step of coating the composition for forming a polymeric interlayer according to various embodiments of the present invention on an anode surface, and a step of polymerizing or curing the coated composition for forming a polymeric interlayer.

According to various embodiments of the present invention, by forming a multiphase SEI-engineered polymeric interlayer (MSEPI), i.e., an in-situ artificial SEI (a-SEI), interfacial instability between lithium metal and SSE can be resolved to stabilize the interface, particularly in high energy density all-solid-state lithium metal batteries (ASLMBs) using sulfide solid electrolytes (SSE).

Furthermore, the polymeric interlayer according to various embodiments of the present invention can suppress the presence of free solvent and integrate anions into the solvation structure, thereby improving chemical compatibility with both lithium metal and SSE, and promoting anion-induced decomposition to aid in the formation of LiF-rich SEI components, contributing to interfacial robustness.

Additionally, the polymeric interlayer according to various embodiments of the present invention forms a chemically diverse and thin SEI layer composed of crystalline LiF and Li3N, and this multifunctional interlayer promotes the in-situ formation of a structurally consistent a-SEI, thereby suppressing SEI thickness increase and demonstrating excellent passivation characteristics.

The polymeric interlayer according to various embodiments of the present invention includes a mechanically robust crosslinked polymer network, providing a rigid backbone, which offers a soft yet ion-conductive medium capable of flexibly adapting to surface non-uniformities and volume changes during Li plating/stripping.

All-solid-state batteries using lithium metal coated with the polymeric interlayer according to various embodiments of the present invention as an anode can exhibit excellent discharge capacity and long-term cycle stability, particularly showing improved rate performance even at higher current densities, and can operate stably for long periods without short-circuiting.

Furthermore, the method for manufacturing an interlayer according to various embodiments of the present invention, by utilizing an liquid monomer system, provides processability that does not require additional solvent use, and enables the direct fabrication of a uniform and scalable polymeric interlayer layer on lithium metal through spin coating, thereby solving the persistent challenges of interfacial instability, dendrite formation, and kinetic limitations.

Additionally, according to some embodiments of the present invention, when Mg3N2 nanoparticles are included as an additive, the formation of Li3N and Mg can be induced through interfacial reactions, thereby improving ionic conductivity and interfacial reaction rates without any degradation of overall battery performance.

### BRIEF DESCRIPTION OF THE DRAWINGS

FIG. 1A schematically illustrates the design and formation process of a MSEPI (Multiphase SEI-engineered Polymeric Interlayer) composition according to an embodiment of the present invention.

FIG. 1B shows photographs comparing the visual reactivity between solutions containing different concentrations of lithium salt (LE1:1 m LiFSI in DME, LE2:11 m LiFSI in DME) and Control 2 (11 m LiFSI in DME/ETPTA) and a sulfide solid electrolyte (LPSCl).

FIG. 1C shows Raman spectra for DME peaks of 1 m LiFSI in DME and 11 m LiFSI in DME solutions.

FIG. 1D shows normalized ionic conductivities of LPSCl after treatment with different electrolytes (LE1, LE2, Control 2).

FIG. 1E shows Raman spectra for FSI-species in 1 m LiFSI in DME and 11 m LiFSI in DME solutions.

FIG. 1F shows full-range Raman spectra for FSI-species in 1 m LiFSI in DME and 11 m LiFSI in DME solutions.

FIG. 1G shows 7Li-1H NOESY spectra for 1 m LiFSI in DME and 11 m LiFSI in DME systems.

FIG. 1H shows 19F-1H NOESY spectra for 1 m LiFSI in DME and 11 m LiFSI in DME systems.

FIG. 1I shows an additional 19F-1H NOESY spectrum for the 11 m LiFSI in DME system.

FIG. 2A is a cross-sectional polished scanning electron microscopy (CP-SEM) image of lithium (Li) metal coated with MSEPI according to an embodiment of the present invention.

FIG. 2B is top surface scanning electron microscopy (SEM) images of lithium (Li) metal coated with MSEPI (left) and untreated lithium (Li) metal (right).

FIG. 2C is a laser scanning confocal microscopy (LSCM) image confirming the surface uniformity of MSEPI according to an embodiment of the present invention.

FIG. 2D shows electrochemical impedance spectroscopy (EIS) results (Nyquist plot) to confirm the ionic conductivity of MSEPI and Control 2.

FIG. 2E shows X-ray diffraction (XRD) patterns of LPSCl pellets in contact with MSEPI-coated lithium.

FIG. 2F shows electrochemical impedance spectroscopy (EIS) results (Nyquist plot) of a MSEPI|LPSCl|MSEPI symmetric cell.

FIG. 2G shows ³¹P NMR spectra confirming the stability of the LPSCl structure after long-term lithium (Li) contact in a symmetric cell using MSEPI-coated lithium.

FIG. 2H shows a graph comparing the critical current density (CCD) of MSEPI-coated lithium (Li) metal and untreated lithium (Li) metal.

FIG. 2I shows the long-term constant current cycling performance of a Li|LPSCl|Li symmetric cell using MSEPI-coated lithium (Li) metal.

FIG. 2J shows a graph comparing the critical current density (CCD) of MSEPI-coated lithium (Li) metal according to ETPTA monomer content (3.5 wt % vs 15 wt %).

FIG. 2K shows a graph comparing the critical current density (CCD) of MSEPI-coated lithium (Li) metal according to Mg3N2, AlN, and LLZTO additives.

FIG. 2L shows a graph representing the critical current density (CCD) of an interlayer formed solely with Mg3N2 powder.

FIG. 3A is a cross-sectional scanning electron microscopy (CP-SEM) image of a Li|LPSCl|Li symmetric cell using MSEPI-coated lithium (Li) after cycling.

FIG. 3B shows X-ray photoelectron spectroscopy (XPS) depth profiles (atomic concentration vs, etching time) of the MSEPI-Li interface.

FIG. 3C shows XPS depth profiles of the Li 1s spectrum in MSEPI.

FIG. 3D shows XPS depth profiles of the N 1s spectrum in MSEPI.

FIG. 3E shows XPS depth profiles of the Mg 1s spectrum in MSEPI.

FIG. 3F shows XPS depth profiles of the Li 1s spectrum in Control 2.

FIG. 3G shows XPS depth profiles of additional N 1s spectra, including the concentration change of Mg3N2 peaks in MSEPI.

FIG. 3H shows cryogenic transmission electron microscopy (cryo-TEM) images of artificial solid electrolyte interphase (a-SEI) formed by MSEPI, and fast Fourier transform (FFT) patterns obtained from these cryo-TEM images. Here, Additive refers to Mg3N2, and the data in the upper row are experimental results, while the lower row shows results for control samples without additives. Through this, it can be observed that SEIs based on inorganic materials with SEI thickness and crystallinity were formed relatively uniformly.

FIG. 4 is a schematic diagram of a multifunctional solid electrolyte interphase (SEI) formed by MSEPI.

FIG. 5A shows the rate capability evaluation results of NCM711|Li full cells using MSEPI-coated lithium (Li) and untreated lithium (Li).

FIG. 5B shows the rate capability evaluation results of NCM711|Li full cells using MSEPI-coated lithium (Li) under conditions where charge/discharge currents match.

FIG. 5C shows the long-term cycle performance of an ASLMB applying MSEPI-coated lithium (Li).

### DESCRIPTION OF THE INVENTION

Hereinafter, various aspects and embodiments of the present invention will be described in more detail.

In this specification, expressions such as ‘comprises’, ‘has’, ‘consists of’, ‘is configured with’, etc., unless ‘˜only’ is used, may include other components. Also, in this specification, when a component is expressed in the singular, it also includes cases of multiple components, unless specifically stated otherwise. Furthermore, numerical values or ranges stated in this specification are interpreted to include error ranges, even without separate explicit mention. Also, the expression “X to Y” representing a numerical range in this specification means “X or more and Y or less.”

Unless otherwise defined, all terms used herein, including technical and scientific terms, have the same meaning as commonly understood by one of ordinary skill in the art to which this invention belongs. Terms as defined in commonly used dictionaries should be interpreted as having meanings consistent with their context in the relevant art and should not be interpreted in an idealized or overly formal sense unless expressly defined otherwise in this application.

One aspect of the present invention relates to a composition for forming a polymeric interlayer comprising a monomer and a lithium-solvent complex.

The monomer comprises a polymerizable or curable structure that can be polymerized or cured by heat or light (especially UV).

The lithium-solvent complex comprises lithium and a liquid solvent that forms a complex with the lithium.

According to one embodiment, the liquid solvent is (i) a liquid solvent having a donor number of 10 or more or (ii) a liquid solvent in which the absolute value of the minimum electrostatic potential is greater than the maximum value.

Examples of liquid solvents usable in the present invention include, but are not limited to, dimethoxyethane (DME), dimethoxybutane (DMB), fluorodimethoxybutane (FDMB), diethoxyethane (DEE), fluorodiethoxyethane (FDEEE), and mixtures of two or more thereof.

In the present invention, the monomer solidifies through polymerization or curing on the anode surface, forming a mechanically robust polymer network.

Furthermore, in the present invention, the lithium-solvent complex can be obtained by mixing a small amount of solvent and a lithium salt, and macroscopically, it is a type of gel-like solution, and microscopically, it can be understood as a concept including a coordination compound where the solvent is coordinated as a ligand to lithium ions. In the present invention, the lithium-solvent complex functions to ensure lithium ion transport and electrochemical stability.

According to one embodiment, the monomer may have any one of the following structures, or mixtures thereof.

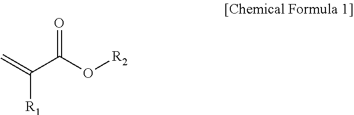

In Chemical Formula 1, R1 is hydrogen or a C1-C6 alkyl group;
R2 is selected from hydrogen, substituted or unsubstituted C1-C6 alkyl group, and

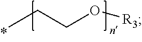

the substituted C1-C6 alkyl group is substituted with a cyano group, an amino group, a monoalkylamino group, or a dialkylamino group, and in the monoalkyl or dialkyl; the alkyl is a C1-C3 alkyl;
R3 is hydrogen or a C1-C6 alkyl group; and
n′ is an integer from 1 to 30, preferably an integer from 1 to 11.

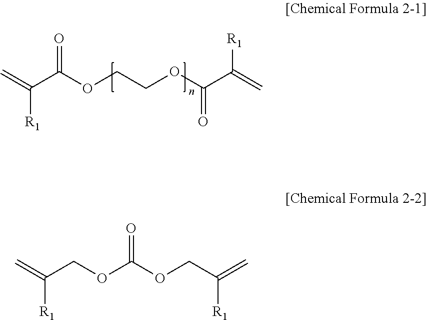

In Chemical Formulas 2-1 and 2-2, R1 is hydrogen or a C1-C6 alkyl group; and
n is a natural number from 1 to 5;

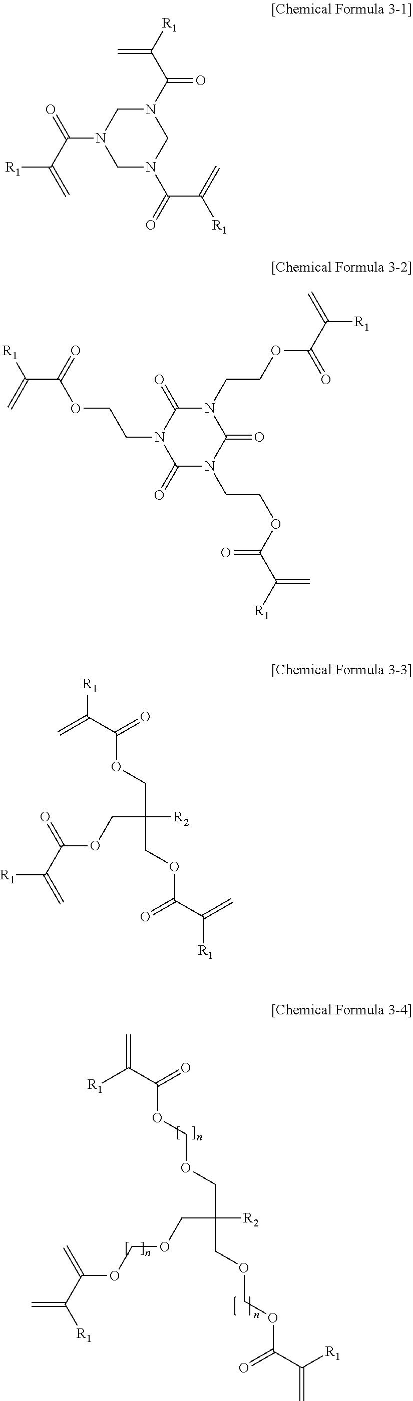

In Chemical Formulas 3-1 to 3-4, R1 is hydrogen or a C1-C6 alkyl group;
R2 is selected from hydrogen, substituted or unsubstituted C1-C6 alkyl group, and

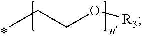

the substituted C1-C6 alkyl group is substituted with a cyano group, an amino group, a monoalkylamino group, or a dialkylamino group, and in the monoalkyl or dialkyl; the alkyl is a C1-C3 alkyl;
R3 is hydrogen or a C1-C6 alkyl group; and
n′ is an integer from 1 to 30, preferably an integer from 1 to 11;
n is a natural number from 1 to 5.

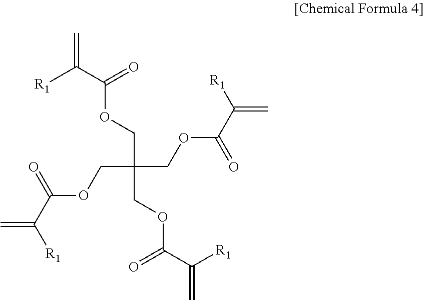

In Chemical Formula 4, R1 is hydrogen or a C1-C6 alkyl group;
R2 is selected from hydrogen, substituted or unsubstituted C1-C6 alkyl group, and

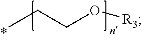

the substituted C1-C6 alkyl group is substituted with a cyano group, an amino group, a monoalkylamino group, or a dialkylamino group, and in the monoalkyl or dialkyl; the alkyl is a C1-C3 alkyl;
R3 is hydrogen or a C1-C6 alkyl group; and
n′ is an integer from 1 to 30, preferably an integer from 1 to 11.

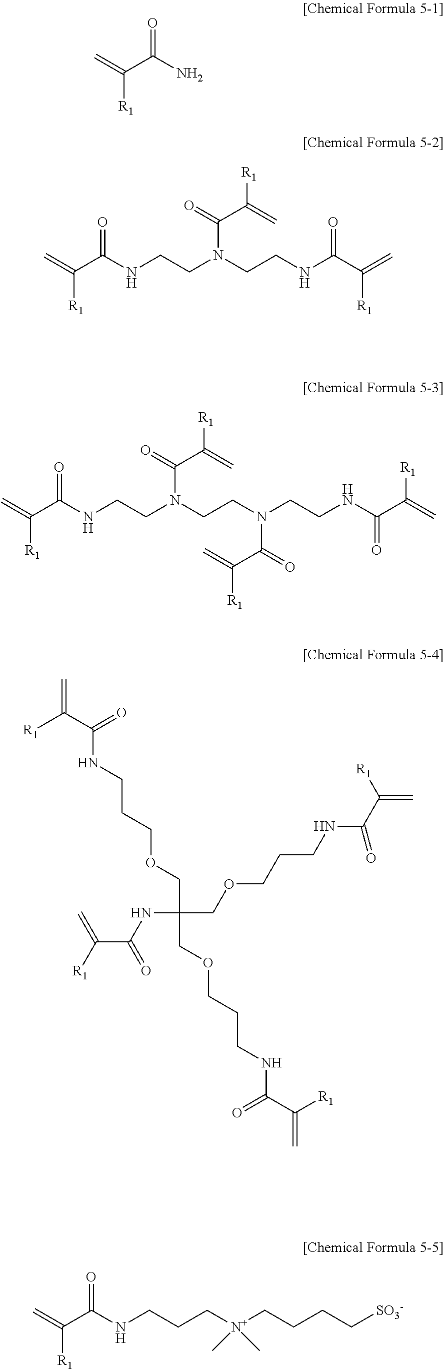

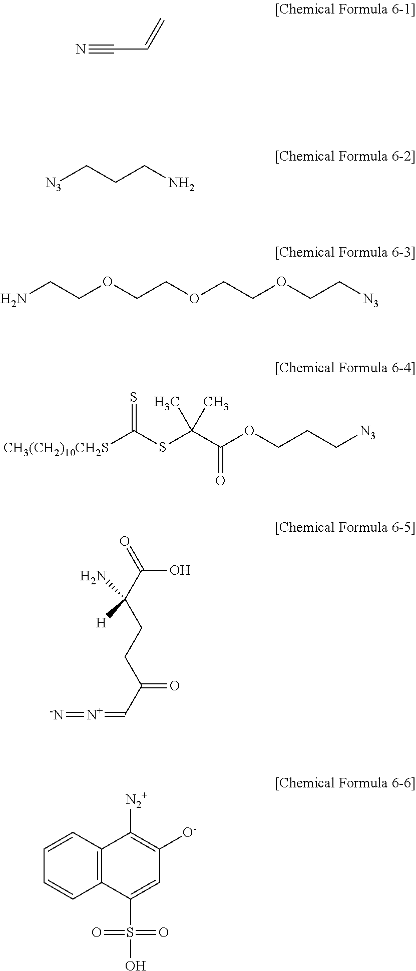

In Chemical Formulas 5-1 to 5-5, R1 is hydrogen or a C1-C6 alkyl group.

According to another embodiment, the monomer may be selected from trimethylolpropane ethoxylate triacrylate (ETPTA), trimethylolpropane propoxylate triacrylate, trimethylolpropane propoxylate trimethacrylate, 1,3,5-triacryloylhexahydro-1,3,5-triazine, tris [2-(acryloyloxy)ethyl] isocyanurate, trimethylolpropane triacrylate, trimethylolpropane trimethacrylate, and mixtures of two or more thereof.

According to yet another embodiment, the monomer may be in a liquid state. By using a liquid monomer in this way, a certain degree of fluidity can be secured, thereby enabling a solvent-free process that does not require additional process solvent later.

According to yet another embodiment, the lithium-solvent complex is a composition for forming a polymeric interlayer wherein the molal concentration of the lithium salt in the solvent is 0.1-30 m.

According to yet another embodiment, the molal concentration of lithium in the solvent of the lithium-solvent complex may be 0.1-30 m, preferably 0.5-25 m, more preferably 1-20 m, even more preferably 5-17 m, and most preferably 7-15 m.

According to yet another embodiment, the weight ratio of the liquid solvent to the monomer may be 60-99:1-40, preferably 70-95:5-30, and most preferably 80-90:10-20.

According to yet another embodiment, the composition further comprises an additive, and the additive may be selected from metal or metalloid nitrides, nitrogen-containing salts of alkali or alkaline earth metals, halide-based additives, oxide-based additives, sulfide-based electrolyte additives, borohydride-based electrolyte additives, metal boron compounds, and carbon-based property improvement additives.

According to yet another embodiment, the metal or metalloid nitride may be selected from Li3N, Na3N, Mg3N2, Ca3N2, Sr3N2, Ba3N2, AlN, TIN, ZrN, HAN, VN, NbN, TaN, CrN, Mo2N, WN, Fe2N, Fe4N, Cu3N, Zn3N2, InN, GaN, ScN, YN, Si3N4, SiNx, BN, c-BN, C3N4, S4N4, (CN) 2, Li3N, and mixtures of two or more thereof.

Furthermore, the nitrogen-containing salt of an alkali or alkaline earth metal may be selected from LiN3, LiCN, LiN(CN)2, LiN(SO2F)2, LiN(SO2CF3)2, LiPF6, LiBOB, LIDFOB, LiTFSI, LIFSI, LiClO4, LiBF4, LiNO3, LiCF3SO3, Mg(N3)2, Mg(CN)2, Mg(ClO4)2, MgNH, Mg(NO3)2, NaN3, KN3, NaNO3, NaFSI, and mixtures of two or more thereof.

Furthermore, the halide-based additive is selected from LiF, LiCl, LiBr, LiI, MgF2, MgCl2, AgF, and mixtures of two or more thereof.

The oxide-based additive includes Al2O3, ZrO2, TiO2, SiO2, ZnO, MgO, HfO2, CeO2, Y2O3, Sc2O3, Ga2O3, WO3, Ta2O5, Nb2O5, V2O5, MoO3, Li7La3Zr2O12 (LLZO), Li6.4La3Zr1.4Ta0.6O12 (LLZTO), Li7 La3Zr2-xTaxO12, Li3xLa2/3-xTiO3 (LLTO), Li1.3Al0.3Ti1.7 (PO4) 3 (LATP), Li1.4Al0.4Ge1.6 (PO4) 3 (LAGP), Li3PO4, LiPO2F2, LiNbO3, LiTaO3, and mixtures of two or more thereof.

Furthermore, the sulfide-based electrolyte additive may be selected from Li10GeP2S12 (LGPS), Li7P3S11, Li6-xPS5-xCl1+x, Li6PS5Br, Li6PS51, Li3PS4, Li4PS41, Li7P3S11, Li9.5P3S12, Li9.6P3S12, Li2S—P2S5 glass-series, Li2S-GeS2-P2S5, Li2S-SiS2-P2S5, Li3PS4-glass ceramic, Li10SnP2S12, Li10SiP2S12, Li3PS4-oxide composites, and mixtures of two or more thereof.

Furthermore, the borohydride-based electrolyte additive may be selected from LiBH4, Mg(BH4)2, Ca(BH4)2, NaBH4, Li2B12H12, Li2B10H10, Na2B12H12, Li(CB9H10), Li(CB11H12), and mixtures of two or more thereof.

Furthermore, the metal boron compound may be selected from TiB2, MgB2, ZrB2, AlB2, and mixtures of two or more thereof.

Furthermore, the carbon-based property improvement additive may be selected from Acetylene black, Carbon black, Ketjenblack, Super P, Carbon nanotube (CNT), Vapor grown carbon fiber (VGCF), Graphene, Graphite, Amorphous carbon, Hard carbon, Soft carbon, Carbon nanosphere, Carbon aerogel, and mixtures of two or more thereof.

According to a preferred embodiment, the additive may be selected from Mg3N2 nanoparticles, Li3N, LINO3, LIDFOB, AlN, TIN, InN, Zn3N2, MgF2, AgF, LiN3, and mixtures of two or more thereof.

Such preferred additives are those that can organically combine with other components in the system of the present invention to exhibit synergistic effects. For example, Mg3N2 nanoparticles are dispersed within the multiphase SEI-engineered polymeric interface (MSEPI) and react with lithium metal during operation to generate Li3N and Mg, which are Li ion conductive. This in-situ reaction improves ionic conductivity and interfacial reaction rates, promotes Li—Mg alloy formation, and also serves to strengthen mechanical stability.

In addition to Mg3N2, which introduces multivalent ions and forms a nitrogen-based SEI to promote interfacial reactions, when Li3N is used as an additive in the present invention, it can organically interact with the system of the present invention to impart high ionic conductivity and high stability with Li metal.

Furthermore, when LiNO3 or LiDFOB is used as an additive in the present invention, it can organically interact with the system of the present invention to form an SEI and improve battery life.

Furthermore, when AlN, TIN, InN, Zn3N2, and mixtures of two or more thereof are used as additives in the present invention, they can organically interact with the system of the present invention, similar to Mg3N2, to form Li3N and Li-Metal alloy through conversion reactions, along with improved mechanical properties.

Furthermore, when MgF2, AgF, and mixtures thereof are used as additives in the present invention, they can organically interact with the system of the present invention, similar to Mg3N2, to form LiF and Li-Metal alloy through conversion reactions.

Furthermore, when LiN3 is used as an additive in the present invention, it can organically interact with the system of the present invention to induce the formation of a Li3N SEI as a lithium salt and exhibit the effect of improving the ionic conductivity of the interlayer.

According to yet another embodiment, the additive may be 1-20 parts by weight, preferably 5-15 parts by weight, and most preferably 8-12 parts by weight, based on 100 parts by weight of the sum of the monomer and the lithium-solvent complex.

Another aspect of the present invention relates to a polymeric interlayer obtained by polymerizing or curing the composition for forming a polymeric interlayer according to various embodiments of the present invention.

Still another aspect of the present invention relates to a polymeric interlayer comprising a polymer or crosslinked polymer of a monomer according to various embodiments of the present invention, and a lithium-solvent complex dispersed in the polymer or crosslinked polymer.

Still another aspect of the present invention relates to a polymeric interlayer formed by the in-situ electrochemical reaction and conversion of a polymeric interlayer solidified or cured through polymerization or crosslinking and Li metal.

In one embodiment, the polymeric interlayer may further comprise an additive.

The explanations for the monomer, the lithium-solvent complex, and the additive, as well as their weight ratios and contents, are as described above for the composition for forming a polymeric interlayer.

According to another embodiment, one or more diffraction spots may be observed in the Fourier Transform (FFT) pattern corresponding to the cryogenic transmission electron microscopy (cryo-TEM) image of the polymeric interlayer.

The diffraction spots may be at least one of LiF nanocrystals, Li3N nanocrystals, and Li2O nanocrystals, and preferably all of them.

As such, in some embodiments of the present invention, such diffraction spots are observed, and when such diffraction spots are observed through the above analysis, it can be confirmed that it is a polymeric interlayer according to some embodiments of the present invention.

Still another aspect of the present invention relates to a battery comprising an anode, an electrolyte, and a polymeric interlayer formed at the interface between the anode and the electrolyte according to various embodiments of the present invention.

In one embodiment, the anode is lithium metal, and the electrolyte is a sulfide-based solid electrolyte.

Still another aspect of the present invention relates to a device comprising a battery according to various embodiments of the present invention.

The device may be selected from communication devices such as mobile phones, transportation devices such as automobiles, energy storage devices, home appliances such as robot vacuum cleaners or cordless vacuum cleaners, medical devices such as wearable health monitors or insulin pumps, industrial devices such as unmanned work robots or battery-based automation systems, robots for service or manufacturing, aerospace devices such as drones or satellites, and military devices such as unmanned reconnaissance aircraft or wearable electronic devices for soldiers.

Still another aspect of the present invention relates to a method for manufacturing a polymeric interlayer, comprising a step of coating the composition for forming a polymeric interlayer according to various embodiments of the present invention on an anode surface, and a step of polymerizing or curing the coated composition for forming a polymeric interlayer.

In one embodiment, the polymerization or curing may be thermal polymerization or thermal curing, or photopolymerization or photocuring.

Hereinafter, the present invention will be described in more detail through examples, but the scope and content of the present invention cannot be narrowed or limited by the following examples. Furthermore, it is clear that based on the disclosure of the present invention, including the following examples, a person skilled in the art can easily practice the present invention even without specific experimental results, and it is natural that such modifications and alterations fall within the scope of the appended claims.

In addition, the experimental results presented below describe only representative experimental results of the examples and comparative examples, and the respective effects of various embodiments of the present invention not explicitly presented below will be specifically described in the relevant sections.

### EXAMPLES

### Example 1-1: Composition for Forming a Polymeric Interlayer

A composition for forming a polymeric interlayer was prepared by mixing dimethoxyethane (DME), which is a solvent or coordination electrolyte, and lithium bis(fluorosulfonyl)imide (LiFSI), which is a lithium salt, to be 1 m LiFSI in DME.

### Example 1-2: Composition for Forming a Polymeric Interlayer

A composition for forming a polymeric interlayer was prepared in the same manner as in Example 1-1, except that the molal concentration was 11 m instead of 1 m.

### Example 1-3: Composition for Forming a Polymeric Interlayer

A composition for forming a polymeric interlayer was prepared in the same manner as in Example 1-2, except that trimethylolpropane ethoxylate triacrylate (ETPTA) monomer was additionally added, and it was 11 m LiFSI in DME/ETPTA (85/15, w/w).

### Example 1-4: Composition for Forming a Polymeric Interlayer

A composition for forming a polymeric interlayer was prepared in the same manner as in Example 1-3, except that magnesium nitride (Mg3N2) additive was additionally added, and it was added as 11 m LiFSI in DME/ETPTA (85/15, w/w)+10 wt % Mg3N2.

### Example 1-5: Composition for Forming a Polymeric Interlayer

A composition for forming a polymeric interlayer was prepared in the same manner as in Example 1-4, except that 2-hydroxy-2-methylpropiophenone (HMPP) initiator was additionally added at 5 wt % of ETPTA.

### Example 1-6: Composition for Forming a Polymeric Interlayer

A composition for forming a polymeric interlayer was prepared in the same manner as in Example 1-2, except that 11 m LiFSI in DME/ETPTA (96.5/3.5, w/w) was used instead of 11 m LiFSI in DME/ETPTA (85/15, w/w).

### Example 2: Lithium Metal Battery Including a Composite Polymeric Interlayer for Sulfide-Based all-Solid-State Batteries

The compositions for forming a polymeric interlayer of Examples 1-1 to 1-6 were each coated on lithium metal, followed by spin coating, and then UV curing was performed for 60 seconds to form the polymeric interlayer. Spin coating was performed under various conditions such as 500 rpm for 10 seconds, 1000 rpm for 10 seconds, 2000 rpm for 10 seconds, 3000 rpm for 10 seconds, 4000 rpm for 10 seconds, 5000 rpm for 10 seconds, and 8000 rpm for 60 seconds. Using the lithium metal with the interlayer thus formed, a lithium metal battery including a composite polymeric interlayer for sulfide-based all-solid-state batteries was fabricated according to conventional methods.

### Design of Multiphase SEI-Engineered Polymeric Interlayer (MSEPI)

To overcome the limitations of exposed Li interfaces, MSEPI was developed by introducing UV-curable liquid ethoxylated trimethylolpropane triacrylate (ETPTA) monomer to form a mechanically robust backbone through a crosslinked polymer network.

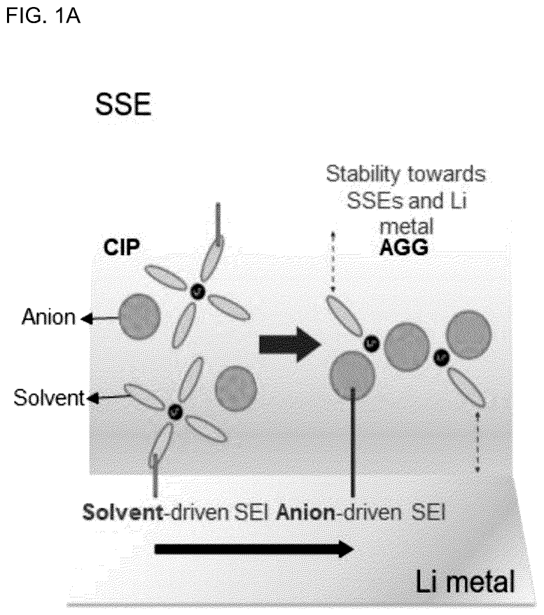

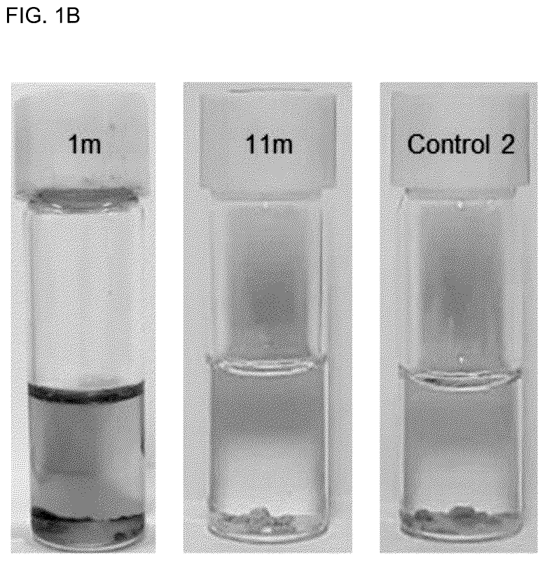

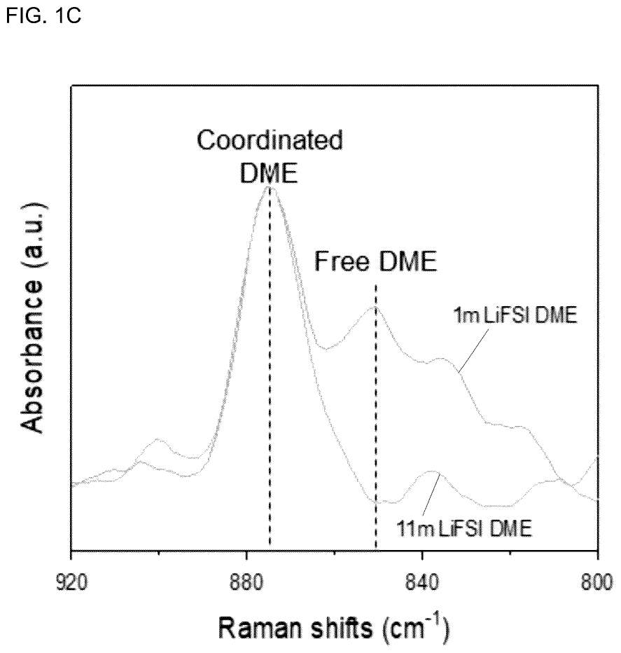

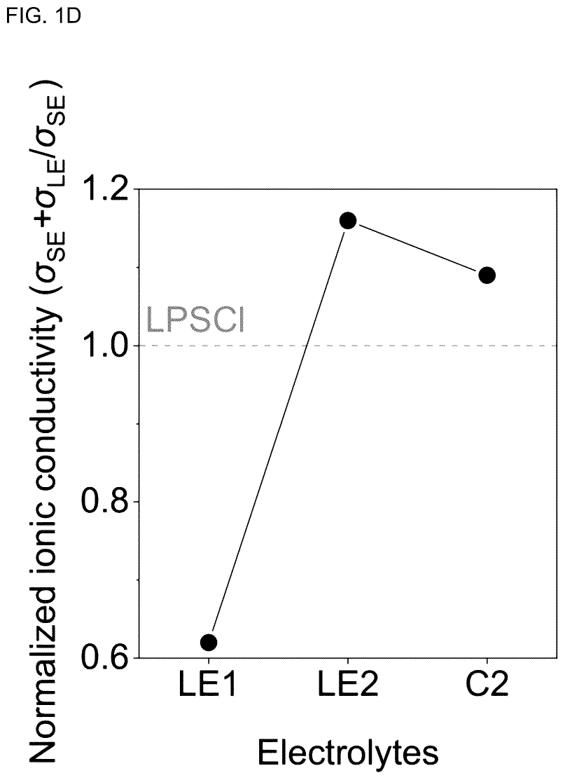

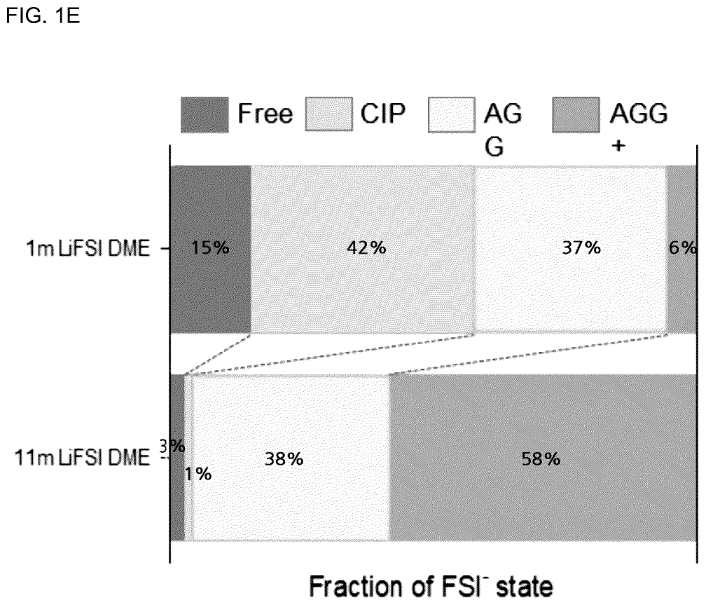

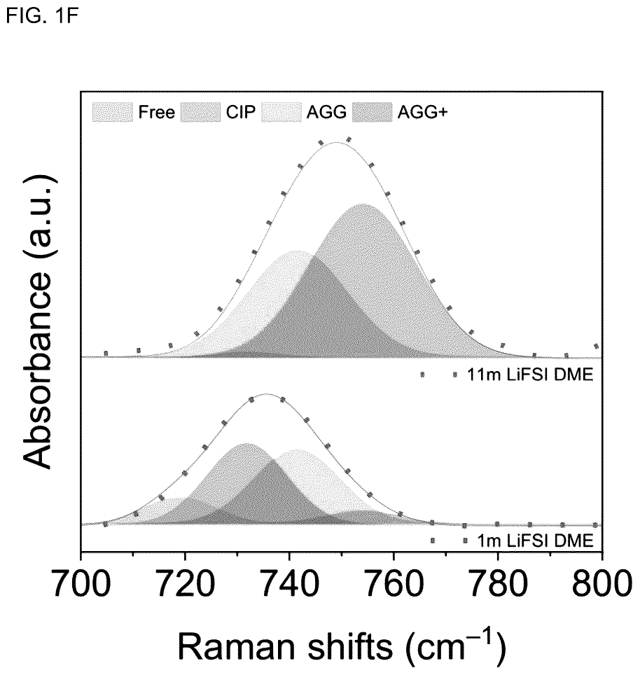

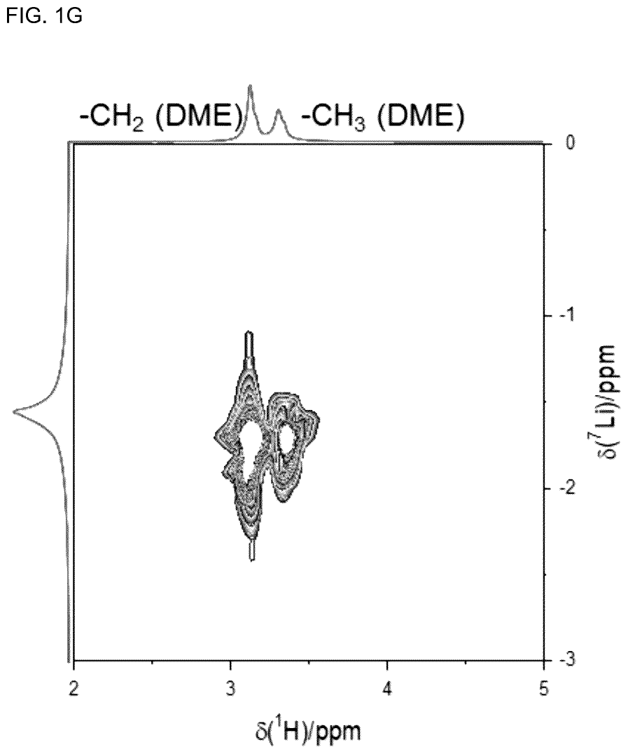

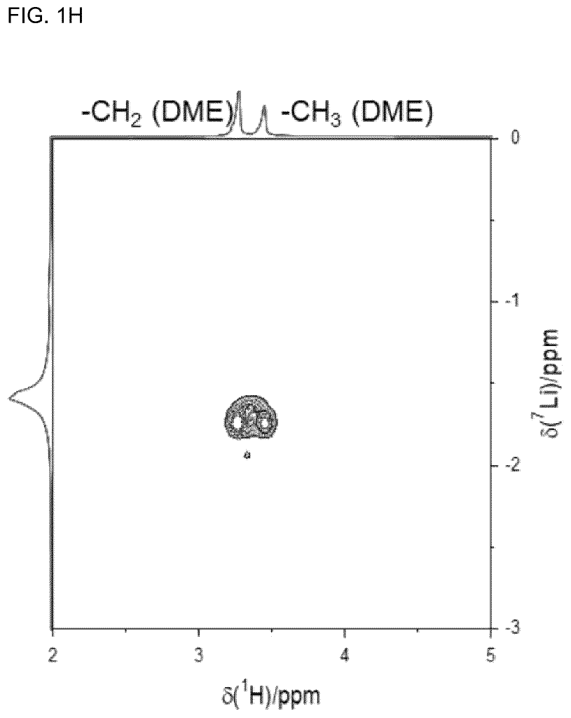

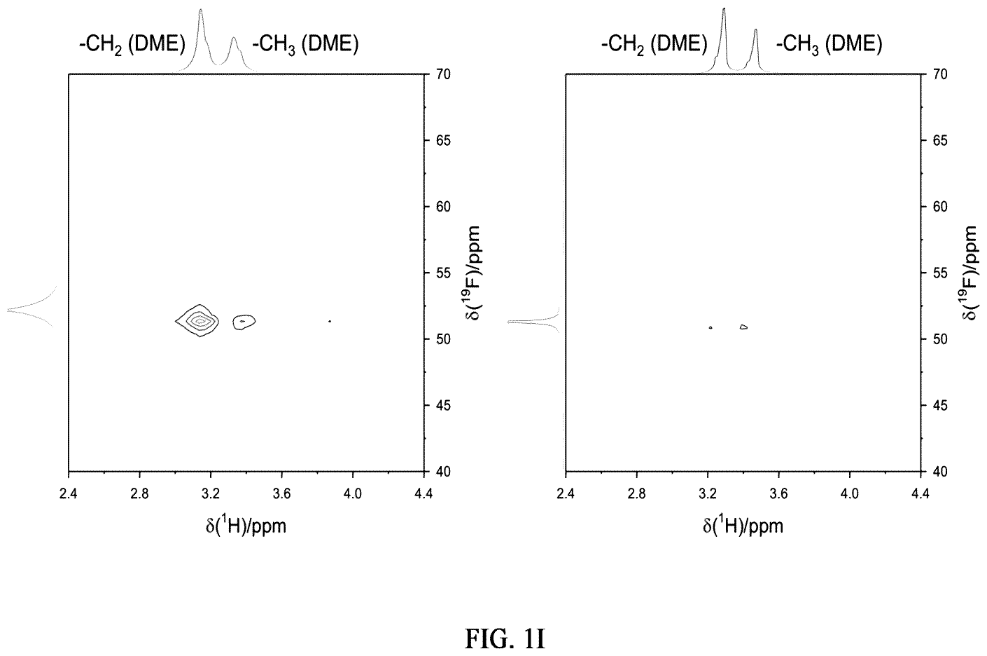

As shown in FIG. 1A, the MSEPI composition was systematically designed to integrate anion-rich coordination structures, enhancing stability towards SSE and Li metal, and modulating decoordination energy to promote fast Li+ transport and uniform SEI formation. For efficient Li+ conductivity, a complex of Li bis(fluorosulfonyl)imide (LiFSI) and dimethoxyethane (DME, G1) was also added to the MSEPI.

To evaluate the chemical compatibility of MSEPI with SSE, two concentrations of polymeric interlayer forming compositions, 1 m (Example 1-1) and 11 m (Example 1-2) LiFSI in DME, were compared based on visual reactivity, ionic conductivity, and coordination structure, using Li6PS5Cl (LPSCl) as the SSE material.

SSE powder was immersed in each solution, and the color change of the initially transparent solution was observed. A distinct color change was observed in the 1 m solution, whereas no change was observed in the 11 m solution (FIG. 1B). This suggests reduced reactivity at high concentrations. To obtain optimal properties, the 11 m solution was made to include 15 wt % ETPTA monomer (Example 1-3, hereinafter ‘control 2’), and this composition also confirmed compatibility with SSE (FIG. 1B).

Raman spectroscopy analysis results indicated that the 11 m solution had a higher proportion of coordinated DME compared to free DME, suggesting reduced chemical reactivity with SSE or Li metal due to solvent coordination stabilization (FIG. 1C).

To confirm the correlation between this coordination behavior and electrochemical stability, the Li+ conductivity of LPSCl exposed to each solution was measured. As shown in FIG. 1D, conductivity significantly decreased after treatment with 1 m LiFSI in DME, whereas conductivity remained stable when treated with 11 m LiFSI in DME and Control 2. This demonstrates that the optimized coordination structure of the 11 m and control 2 compositions suppresses undesirable reactions with both Li metal and SSE.

This modulation of free solvent interaction changes the coordination sequence of Li+ ions, anions, and solvent molecules, allowing anions to participate in coordination and ultimately influence SEI formation. Raman analysis of FSI-species (FIG. 1G and FIG. 1E) confirmed that 1 m LiFSI in DME primarily forms solvent-dominated contact ion pairs (CIP), while the 11 m LiFSI in DME composition promotes aggregated structures (AGG and AGG+) involving anions.

To further elucidate the multifaceted coordination structure of MSEPI, solid-state two-dimensional nuclear Overhauser effect spectroscopy (2D-NOESY) was performed (FIG. 1G). In the 7Li-1H NOESY and 19F-1H NOESY spectra, it was confirmed that the 11 m LiFSI in DME system forms a much more complex and diverse network compared to the 1 m system (FIG. 1H and FIG. 1I).

This diverse coordination network allows DME molecules to extensively interact with Li+ and FSI-species, reducing the proportion of free DME in the system. This is confirmed by strong cross-peaks between Li+ and DME (FIG. 1G), and FSI− and DME (FIG. 1I) in the 2D-NOESY analysis, indicating enhanced solvent coordination in 11 m LiFSI in DME (hereinafter ‘solvent’ or ‘coordination electrolyte’).

Consistent with these 2D-NOESY results, Raman spectroscopy (FIG. 1C) also confirms a significant reduction in the free DME peak in 11 m LiFSI in DME.

This shows that non-coordinated solvent or free DME, which is known to cause side reactions with sulfide-based SSE, is well suppressed in the compositions of Example 1-2 or 1-3.

### Fabrication of MSEPI-Coated Li Metal

Based on the chemically optimized 11 m Li+-G1 complex, nano-sized Mg3N2 powder was introduced as an additive to further engineer an artificial SEI (a-SEI) through in-situ electrochemical conversion. Mg3N2 reacts with Li metal to form Li3N and Mg, which enhance ion transport and Li diffusion, respectively, while also strengthening mechanical stability (Equation 1). The additive was uniformly dispersed within the 11 m Li+-G1 complex through ultrasonic dispersion, and the resulting composition was uniformly and widely coated on the lithium metal surface by spin coating, leveraging the properties of the liquid ETPTA monomer.

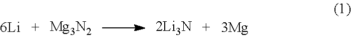

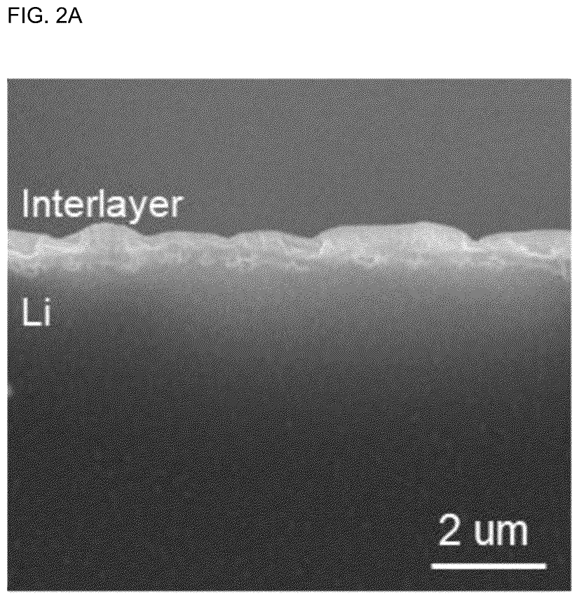

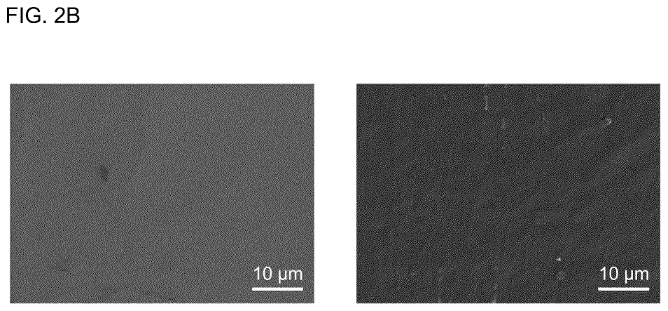

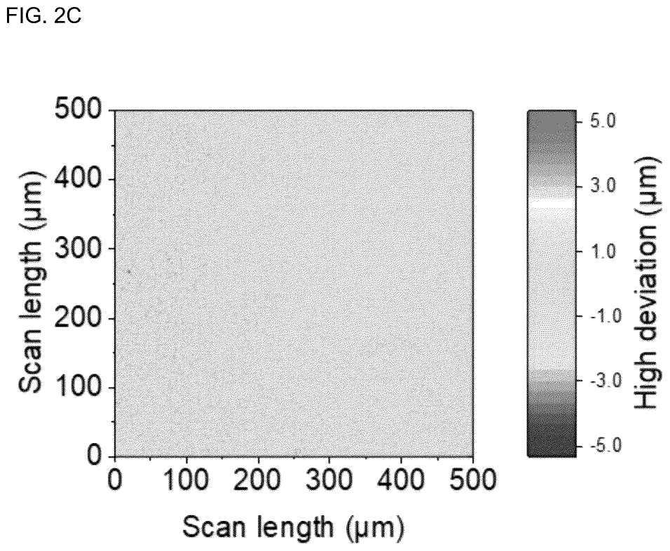

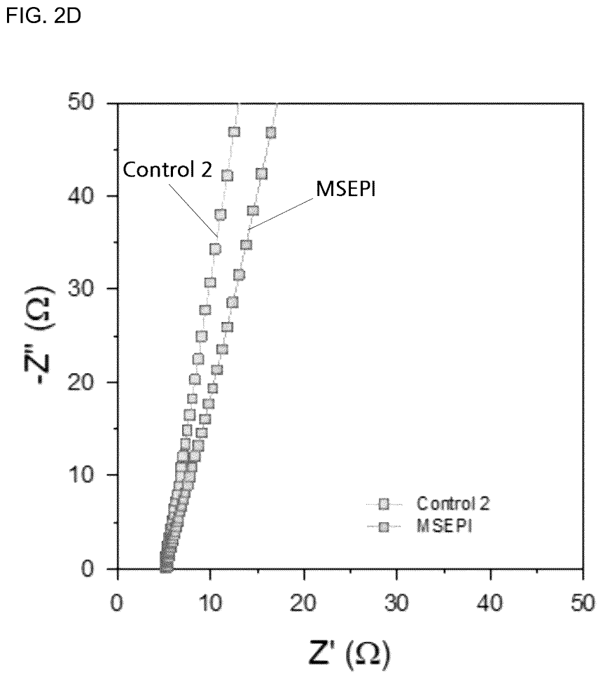

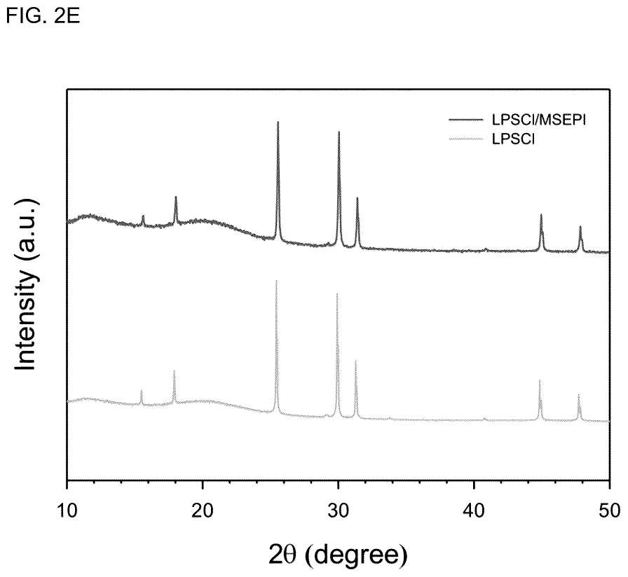

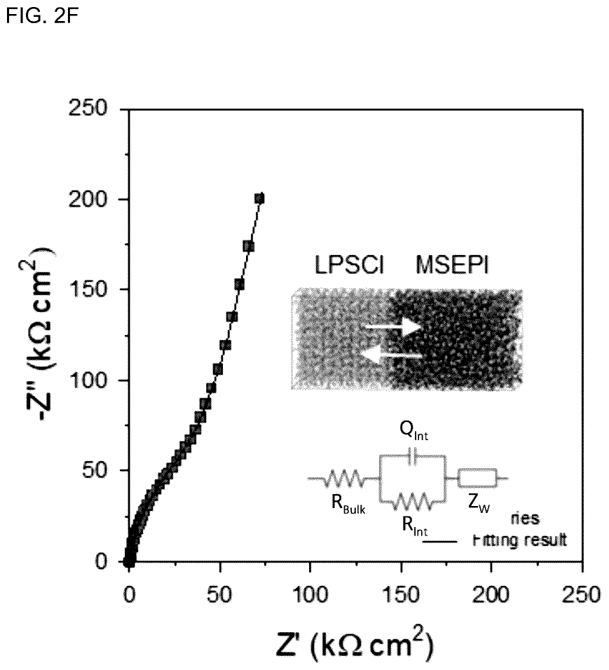

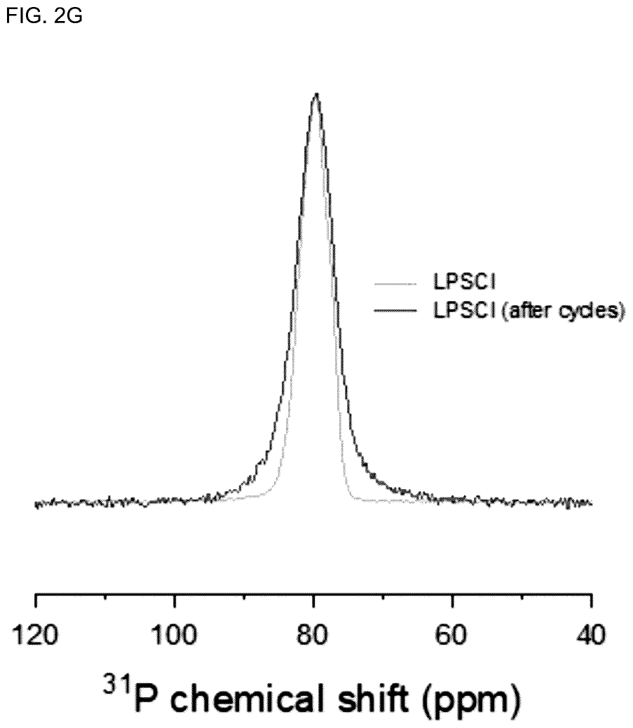

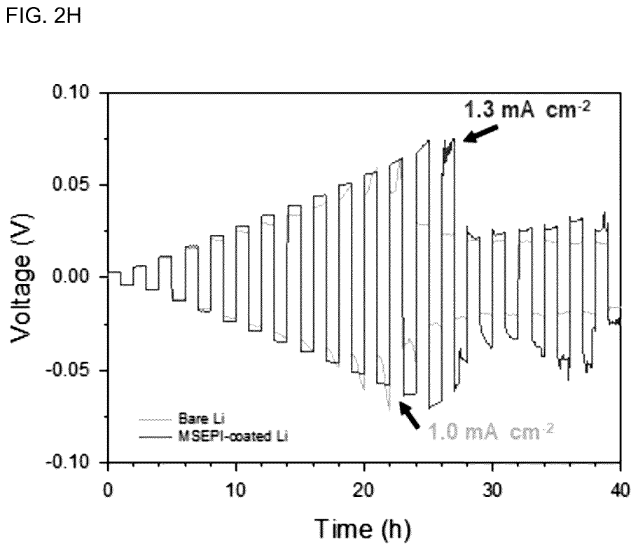

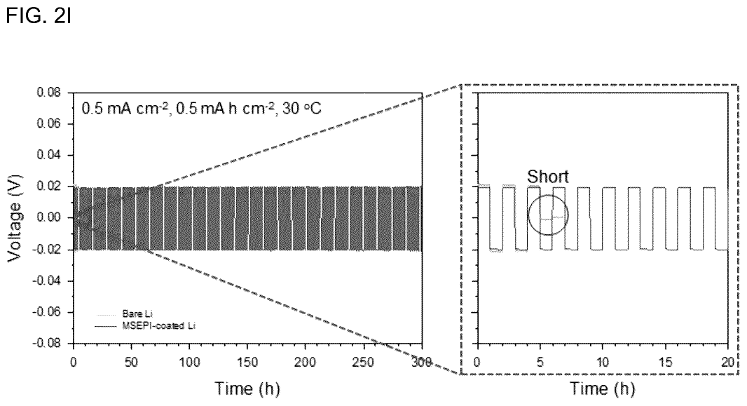

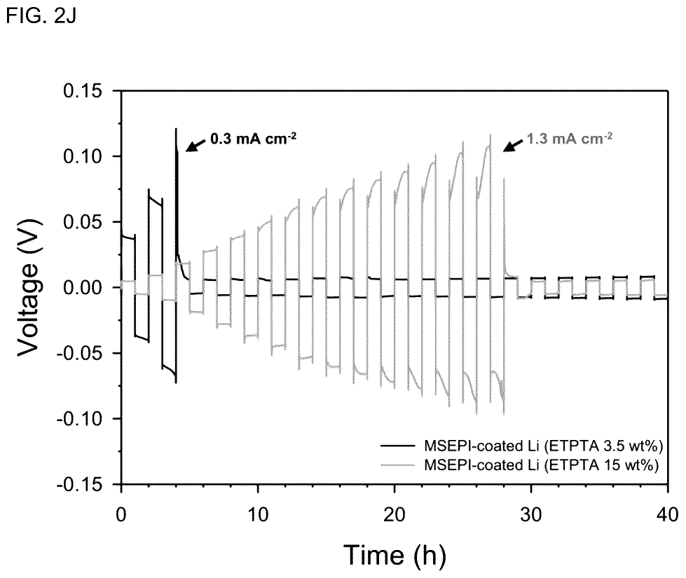

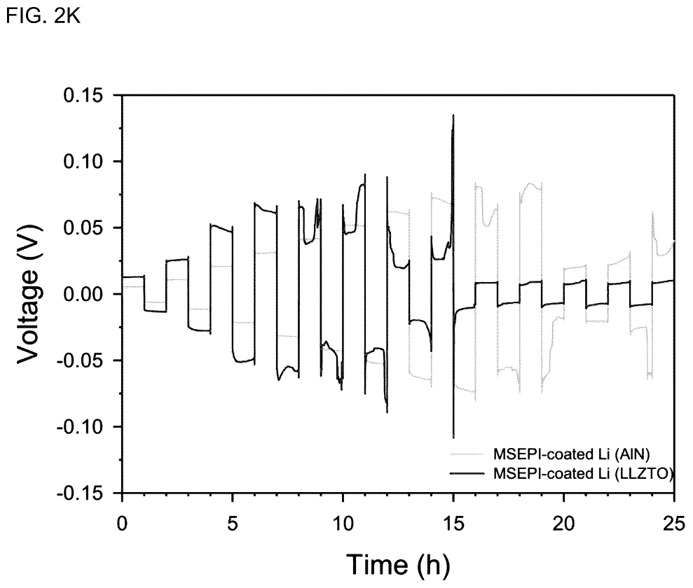

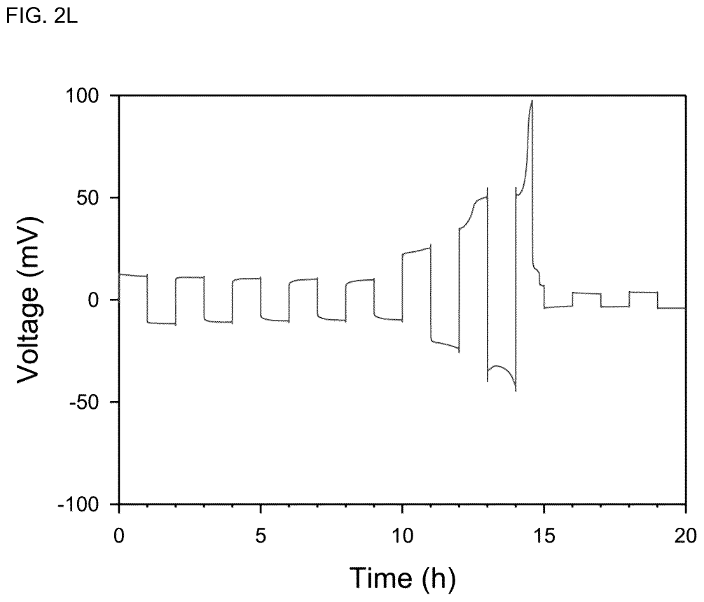

After the coating process, the MSEPI layer was solidified through UV curing to improve mechanical strength. Cross-sectional polished scanning electron microscopy (CP-SEM) images showed that a uniform sub-micron thick coating was formed on the lithium metal surface (FIG. 2A).

Furthermore, surface SEM comparison results showed that lithium coated with MSEPI exhibited a uniform morphology, despite utilizing only a liquid monomer system during manufacturing and following a solvent-free process without using additional processing solvent, whereas untreated lithium showed a relatively rough surface (FIG. 2B, untreated Li on the right).

Additionally, the uniformity of MSEPI-coated lithium was evaluated, and laser scanning confocal microscopy (LSCM) analysis confirmed that the surface of MSEPI was very uniform (FIG. 2C), suggesting that it can play an important role in reducing defects in the SSE layer at the interface with lithium metal.

After confirming that the MSEPI coating process forms a uniform and defect-reducing interface with lithium metal, the introduction of Mg3N2 was further evaluated to determine if it provided the intended benefits while maintaining electrochemical performance.

Electrochemical impedance spectroscopy (EIS) results showed that the addition of Mg3N2 did not adversely affect performance, and the final MSEPI composition exhibited a Li+ conductivity of 7.47×10−4 S cm−1 at 30° C. (FIG. 2D).

The structural stability of MSEPI in contact with LPSCl was further verified through X-ray diffraction (XRD) analysis of LPSCl pellets in contact with MSEPI-coated lithium, and no structural degradation was observed (FIG. 2E).

EIS measurements in a symmetric serial cell configuration (MSEPI|LPSCl|MSEPI) confirmed efficient Li+ conduction through the interlayer (FIG. 2F). Furthermore, 31P NMR analysis of a symmetric cell using MSEPI-coated lithium confirmed that the LPSCl structure was maintained even after long-term Li contact (FIG. 2G).

The electrochemical performance of MSEPI-coated lithium was evaluated in Li|LPSCl|Li symmetric cells at 30° C. and 1.5 MPa operating pressure, conditions representing significant mechanical and electrochemical challenges for the lithium metal interface. The critical current density (CCD) was measured by incrementally increasing the current density and area capacity by 0.1 mA cm−2 and 0.1 mA h cm−2, respectively (FIG. 2H).

MSEPI-coated lithium achieved a CCD of 1.3 mA cm−2, showing superior rate characteristics compared to untreated lithium (1.0 mA cm−2). Furthermore, long-term constant current cycling results at 0.5 mA cm−2, 0.5 mA h cm−2/cycle showed stable operation for over 300 hours without short-circuiting, demonstrating the protective and conductive functions of the MSEPI layer (FIG. 2I).

To better understand the cause of this electrochemical performance improvement, the ETPTA monomer content and the synergistic role of Mg3N2 were further investigated. In particular, the ETPTA monomer content was designed to act as a mechanical backbone. 15 wt % ETPTA without additives (Example 1-3, Control 2) showed better performance in CCD evaluation compared to 3.5 wt % ETPTA (Example 1-6), suggesting the importance of ETPTA's structural role in forming a robust interlayer as well as its mechanical reinforcement effect for MSEPI (FIG. 2J).

Interestingly, the CCD value of MSEPI containing Mg3N2 was even higher than that of MSEPI containing additives known for high mechanical strength, such as LLZTO and AlN (FIG. 2K). This suggests that the superior performance of MSEPI containing Mg3N2 cannot be fully explained by simple mechanical reinforcement alone, and that various components of the present invention are organically combined to synergistically enhance the effects of the present invention.

To clarify the functional role of the polymer matrix, a CCD evaluation was performed by applying only Mg3N2 powder as an interlayer to lithium metal (FIG. 2L). In this case, the CCD was significantly low at 0.3 mA cm−2, meaning that Mg3N2 powder alone, due to its particle characteristics, has difficulty forming a dense and uniform contact with the electrolyte and is thus difficult to effectively apply as an interfacial layer. The powder-based interlayer, approximately 30 μm thick, lacked the cohesive mechanical framework and continuous ionic conductive medium provided by the MSEPI composition. This result demonstrates that the polymer matrix within MSEPI is crucial in providing a continuous Li+ conductive medium, allowing Mg3N2 to act as an effective electrochemically active additive, and that the observed performance improvement results from a synergy with the polymer matrix, not from the additive alone.

### Characterization of Solid Electrolyte Interphase (SEI) Layer

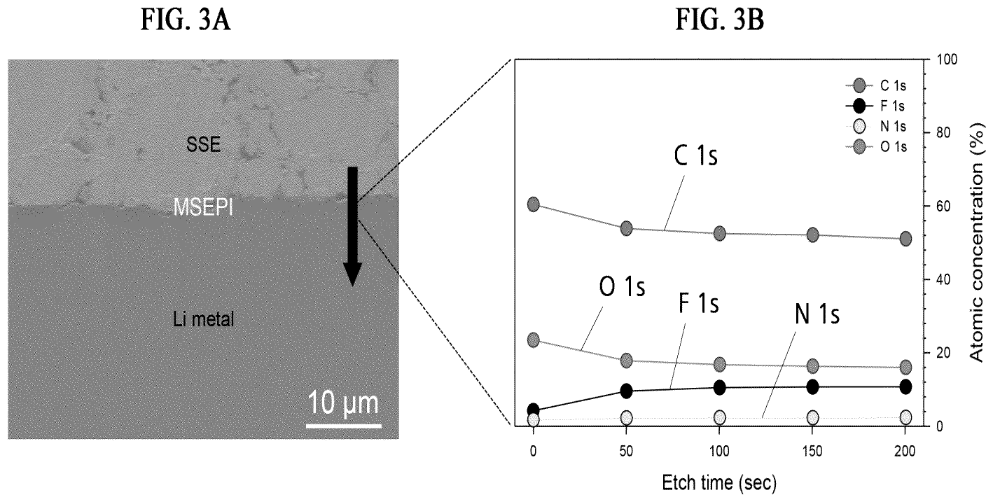

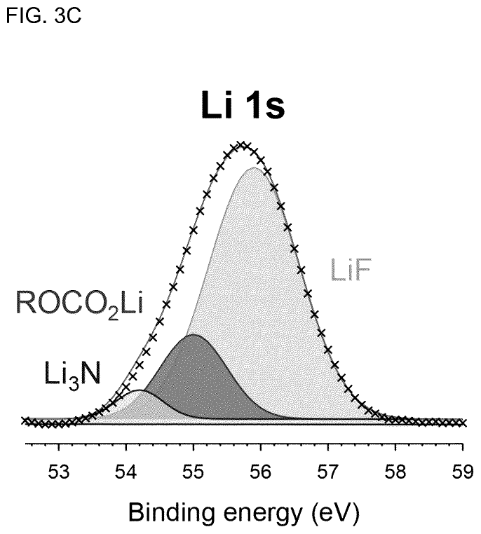

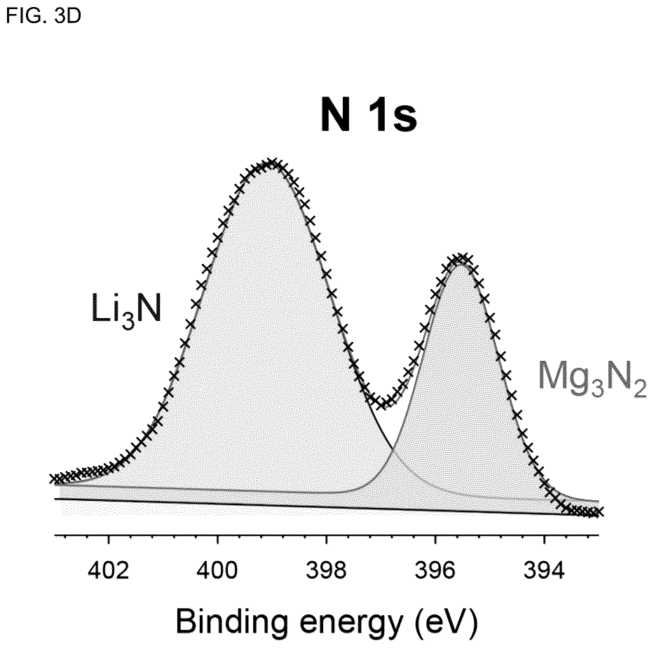

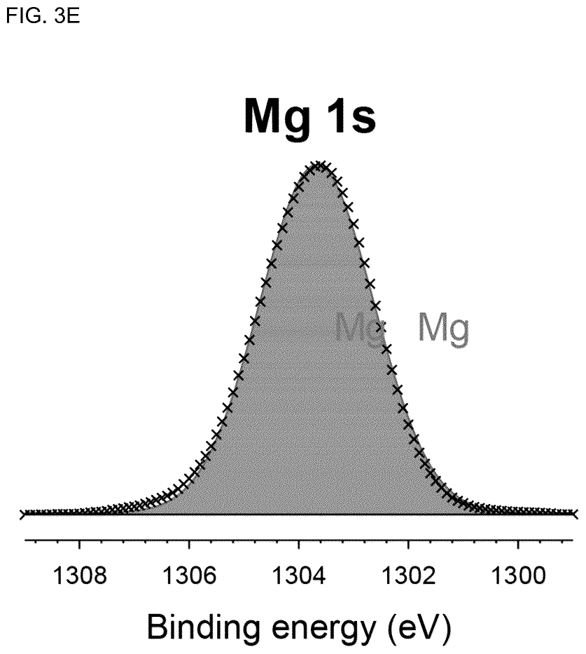

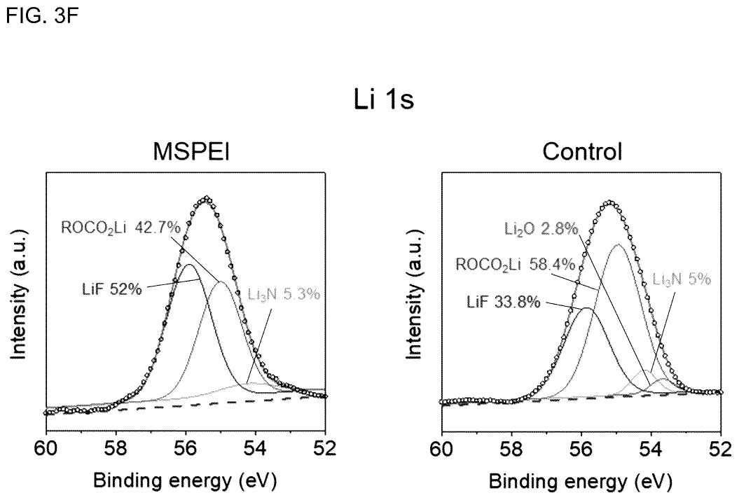

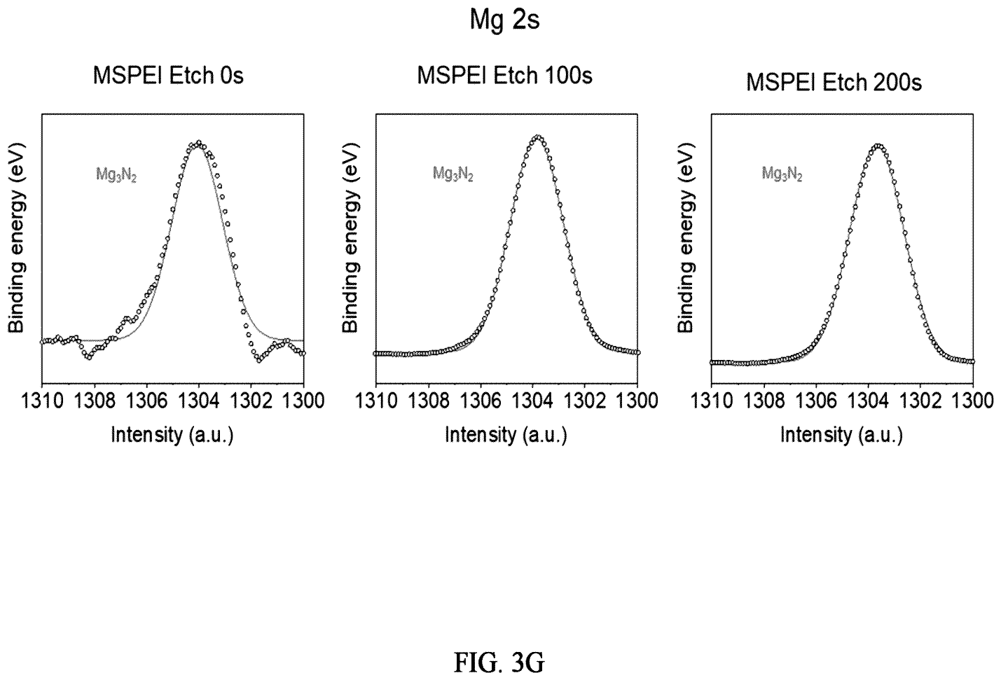

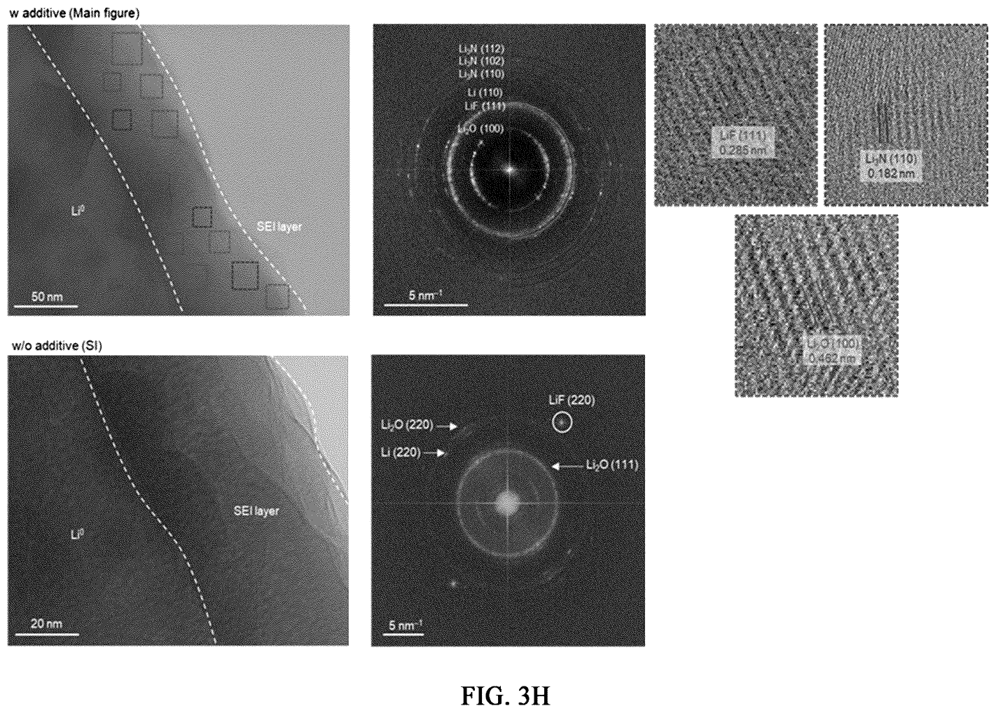

To gain a deeper understanding of the interfacial stabilization mechanism realized by MSEPI, comprehensive post-mortem analysis was performed after electrochemical cycling. FIG. 3A shows a cross-sectional scanning electron microscopy (CP-SEM) image of a Li|LPSCl|Li symmetric cell after cycling using MSEPI-coated Li, confirming the formation of a clear and uniform interface between the SSE and Li metal. This uniform contact demonstrates that MSEPI effectively maintains interfacial integrity even under repetitive cycling conditions.

The compositional characteristics of the SEI were investigated through X-ray photoelectron spectroscopy (XPS) analysis. FIG. 3B shows the XPS depth profile of the interface structure between SSE and Li metal.

As etching time increased, the atomic concentration of inorganic species increased, indicating the formation of a gradient-structured SEI at the MSEPI-Li interface. Simultaneously, the C signal decreased, while the F and N signals increased, meaning that a layered SEI structure was formed where inorganic materials accumulated on the Li metal side according to the reductive decomposition process.

To analyze the specific inorganic phases of this layered structure, depth profile XPS was performed. The Li 1s spectrum provides important information about the SEI composition, and in MSEPI, the Li3N and LiF signals gradually increased with etching depth, showing the formation of a heterogeneous SEI structure rich in ion-conductive Li3N and mechanically robust LiF domains (FIG. 3C).

This mosaic structure suppresses dendrite growth while simultaneously enhancing Li+ diffusion through grain boundary pathways, whereas in Control 2, Li3N formation was limited, and a predominantly LiF-rich SEI was formed, which was relatively dense and less permeable, tending to hinder efficient Li+ transport (FIG. 3F).

Further analysis of the N 1s spectrum revealed that in MSEPI, the intensity of the Mg3N2 peak gradually increased with etching depth, indicating that Mg3N2 was concentrated on the Li metal side (FIG. 3D). This suggests that Li—Mg alloy formation is effectively promoted at the interface. Complementarily, clear Mg signals were also observed in the Mg 1s spectrum for MSEPI, supporting this (FIG. 3E).

To elucidate the nanostructural characteristics of the MSEPI-derived SEI, cryogenic transmission electron microscopy (cryo-TEM) analysis was performed, which allows direct observation of beam-sensitive battery materials at the atomic level. FIG. 3H shows that the a-SEI formed on the Li metal surface exhibits a highly uniform and tightly adhered structure. This contrasts sharply with the thick, non-uniform, and irregular morphology of the Control SEI. The reduction in thickness is attributed to the dense and uniform crystalline structure achieved by MSEPI, which effectively minimizes electrolyte penetration and subsequent degradation.

The corresponding Fourier Transform (FFT) pattern provides crucial information about the crystallographic characteristics of this dense structure. Distinct diffraction spots corresponding to LiF, Li3N, and Li2O nanocrystals are observed in the pattern. These inorganic crystalline phases are produced through the electrochemical decomposition of LiFSI and the conversion reaction with Mg3N2, providing both fast Li+ transport and mechanical robustness. The formation of these well-defined crystalline domains induced by MSEPI leads to the observed dense and uniform SEI structure.

These XPS and cryo-EM analysis results demonstrate that MSEPI enables the formation of a robust artificial SEI with tailored nanostructure and chemical composition. This multifunctional interfacial layer provides the foundation for a stable Li-SSE interface, demonstrating the potential of molecular-level interface engineering in the development of solid-state batteries.

The impact of the MSEPI-derived SEI on interfacial reaction kinetics was further evaluated through electrochemical analysis. Tafel plot analysis showed that the exchange current density of MSEPI was significantly higher than that of Control 2, indicating enhanced charge transfer kinetics at the Li interface. This improvement is attributed to the presence of ion-conductive Li3N and mechanically robust LiF domains within the SEI, which promote fast Li+ transport and efficient interfacial reactions.

Consistent with this, electrochemical impedance spectroscopy (EIS) results for Li|Li symmetric cells showed that MSEPI exhibited a significant reduction in interfacial resistance and charge transfer resistance compared to Control 2. The reduction in resistance further demonstrates the formation of a kinetically favorable interfacial environment realized by the engineered SEI structure. The evolution of interfacial stability was also investigated in Li∥Cu cells. While both MSEPI and Control 2 showed similar initial overpotentials in early cycles, a distinct difference emerged in long-term cycling. In MSEPI, the overpotential gradually decreased, likely due to the progressive formation of Li—Mg alloy and a stabilized SEI structure. In contrast, in Control 2, the overpotential increased, reflecting continuous interfacial degradation and the accumulation of a resistive SEI layer.

These results comprehensively suggest that the MSEPI-derived heterogeneous SEI not only suppresses dendrite growth but also promotes fast interfacial Li+ transport, thereby achieving stable and efficient electrochemical performance.

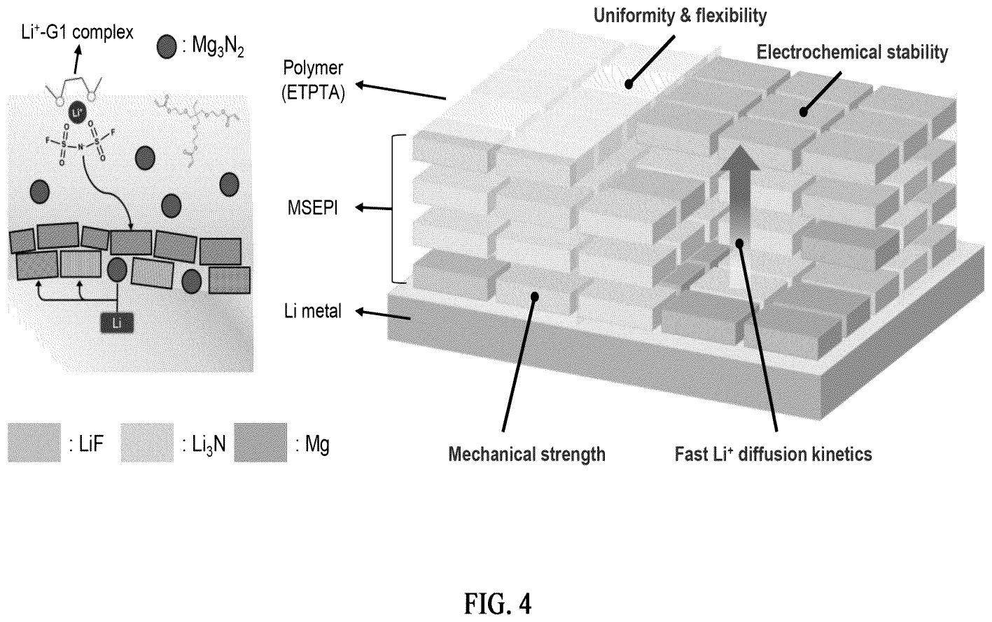

FIG. 4 presents a schematic diagram of the multifunctional SEI formed through MSEPI, illustrating a mosaic structure with interconnected inorganic and organic domains. This hierarchical design not only stabilizes the interface and suppresses Li dendrite growth but also promotes efficient Li+ transport, enabling enhanced electrochemical performance of sulfide-based ASLMBs.

### Electrochemical Performance of MSEPI-Coated Lithium Metal

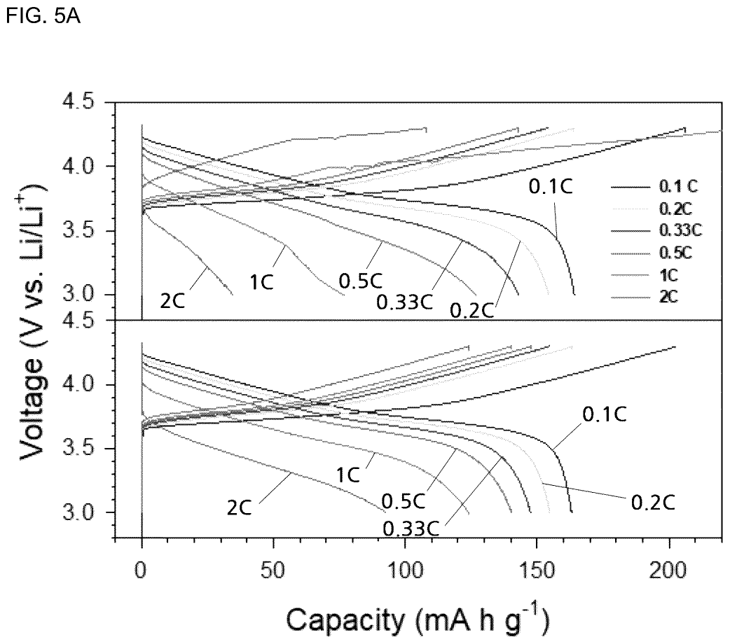

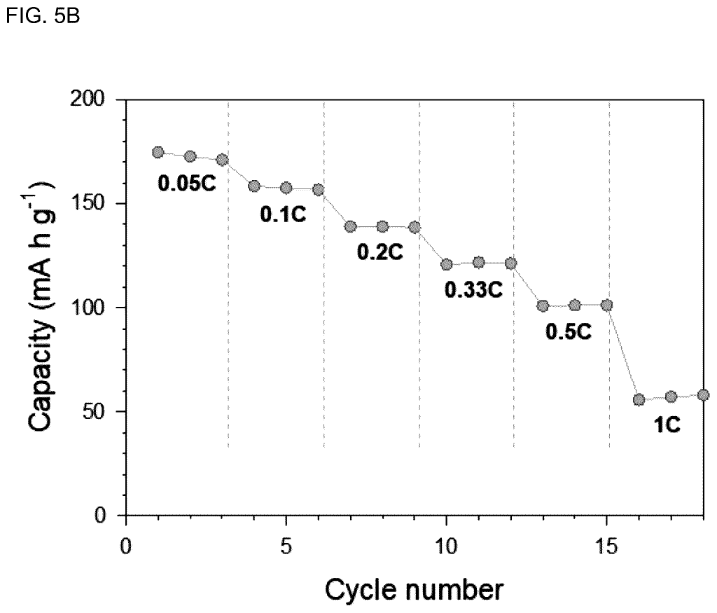

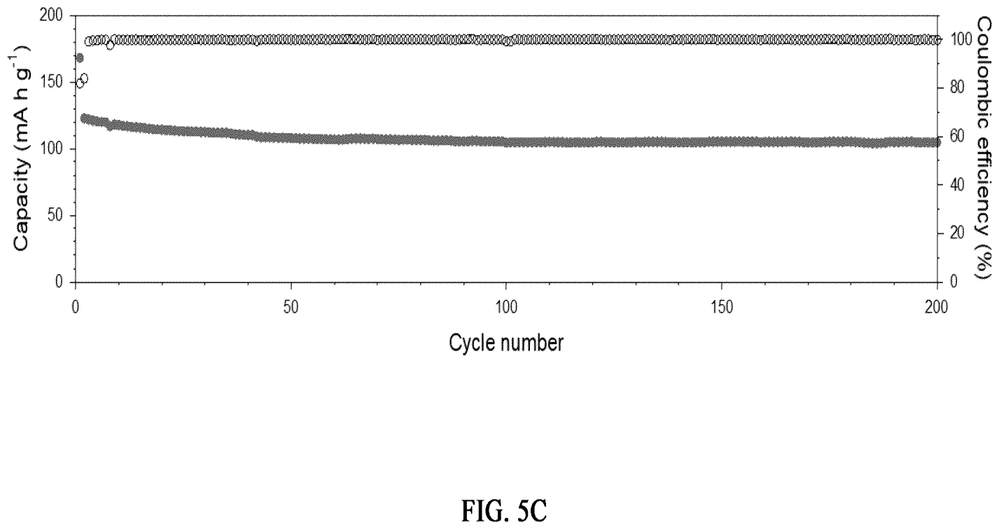

Based on the structural and chemical characteristics of the artificial SEI formed through MSEPI, we further evaluated the electrochemical performance of NCM711|Li full cells applying MSEPI-coated lithium metal. All full cell experiments were conducted at 30° C. and 1.5 MPa, using sulfide SSE powder-based pellets fabricated by uniaxial pressing. FIG. 5A shows the rate capability evaluation results performed in a voltage range of 3.0-4.3 V, where the discharge rate was varied from 0.1 C (0.19 mA cm−2) to 2.0 C (3.85 mA cm−2), and the charge rate was fixed at 0.1 C.

For comparison, analysis of NCM711|Li full cells using untreated lithium was also conducted under the same conditions (FIG. 5A). All electrochemical evaluations were performed at an operating pressure of 1.5 MPa at 30° C. Cells applying MSEPI-coated lithium exhibited significantly superior rate performance under all conditions. In contrast, cells using untreated lithium experienced a short-circuit at 0.5 C (0.95 mA cm−2), demonstrating their inability to withstand high current densities due to interfacial degradation or dendrite-induced failure. This phenomenon reflects the instability of conventional Li-SSE interfaces, which cannot accommodate rapid Li+ flux without dendrite or void formation. The robust performance of MSEPI-coated lithium at high current densities is attributed to the presence of a structurally consistent and ionically conductive a-SEI, as confirmed by previous cryo-TEM and XPS analyses. The chemically engineered SEI induces uniform Li+ flux and suppresses morphological instability that occurs during high-rate operation.

In additional rate tests where charge and discharge currents were matched (FIG. 5B), MSEPI-coated lithium confirmed reversible Li plating/stripping under various operating conditions, demonstrating that the interlayer can maintain electrochemical and mechanical integrity.

The long-term cycle performance of an ASLMB applying MSEPI-coated lithium is presented in FIG. 5C. This cell exhibited high initial discharge capacities of 168 mA h g−1 at 0.05 C and 122.7 mA h g−1 at 0.33 C, achieving a capacity retention rate of 85% over 200 cycles, demonstrating long-term stability. These results show that the MSEPI interlayer not only protects the lithium metal surface but also enables efficient Li+ transport at the Li-SSE interface even under the demanding conditions of full cell operation.

Overall, by applying MSEPI in practical cell configurations, the polymeric interlayer-derived a-SEI layer demonstrates the potential to solve persistent problems such as interfacial instability, dendrite formation, and kinetic limitations in sulfide-based ASLMBs.

Although specific parts of the present invention have been described in detail above, it is clear to those skilled in the art that such specific descriptions are merely preferred embodiments and that the scope of the present invention is not limited thereto. Therefore, the actual scope of the present invention is defined by the appended claims and their equivalents.

What is claimed is:

1. A polymeric interlayer comprising a polymer or crosslinked polymer of a monomer and a lithium-solvent complex dispersed in the polymer or crosslinked polymer, wherein the monomer comprises a polymerizable or curable structure that can be polymerized or cured by heat or light (especially UV), and the lithium-solvent complex comprises a lithium salt and a liquid solvent, wherein the liquid solvent is (i) a solvent having a donor number of 10 or more or (ii) a solvent in which the absolute value of the minimum electrostatic potential is greater than the maximum value.

2. The polymeric interlayer according to claim 1, wherein the monomer has any one of the following structures, or mixtures thereof: 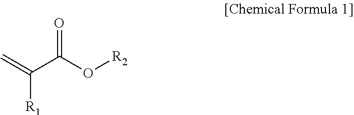
in Chemical Formula 1, R1 is hydrogen or a C1-C6 alkyl group;
R2 is selected from hydrogen, substituted or unsubstituted C1-C6 alkyl group, and 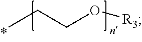
wherein the substituted C1-C6 alkyl group is substituted with a cyano group, an amino group, a monoalkylamino group, or a dialkylamino group; the alkyl is a C1-C3 alkyl;
R3 is hydrogen or a C1-C6 alkyl group; and
n′ is an integer from 1 to 30; 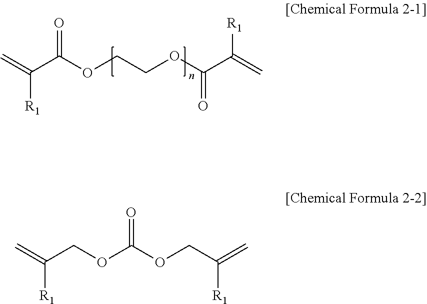
in Chemical Formulas 2-1 and 2-2, R1 is hydrogen or a C1-C6 alkyl group; and
n is a natural number from 1 to 5; 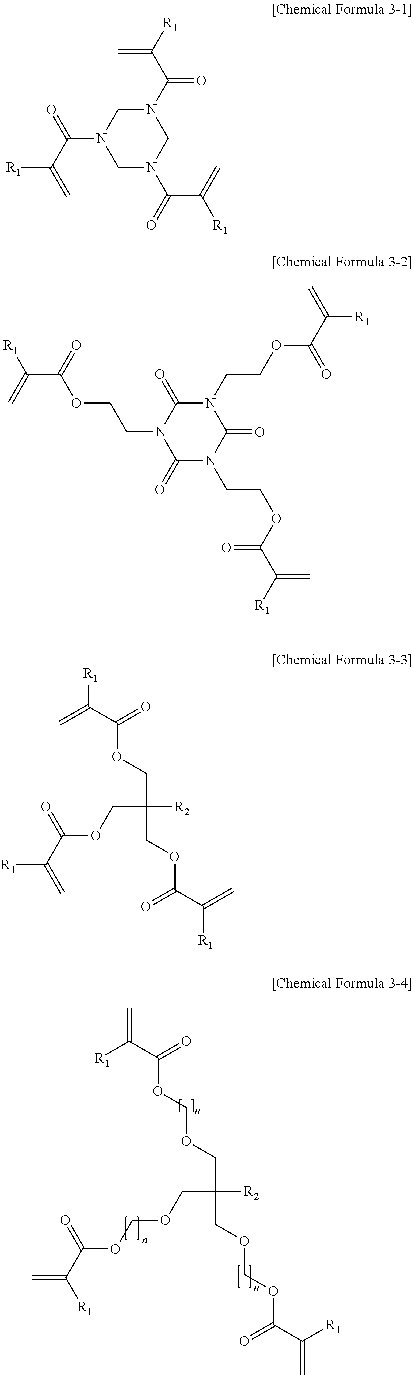
in Chemical Formulas 3-1 to 3-4, R1 is hydrogen or a C1-C6 alkyl group;
R2 is selected from hydrogen, substituted or unsubstituted C1-C6 alkyl group, and 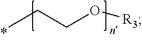
wherein the substituted C1-C6 alkyl group is substituted with a cyano group, an amino group, a monoalkylamino group, or a dialkylamino group; the alkyl is a C1-C3 alkyl;
R3 is hydrogen or a C1-C6 alkyl group;
n′ is an integer from 1 to 30; and
n is a natural number from 1 to 5; 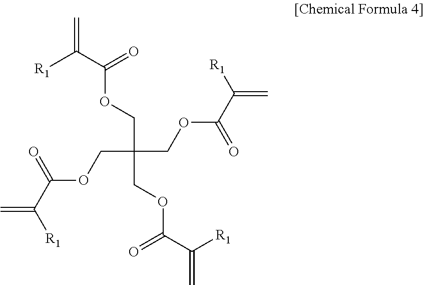
in Chemical Formula 4, R1 is hydrogen or a C1-C6 alkyl group;
R2 is selected from hydrogen, substituted or unsubstituted C1-C6 alkyl group, and 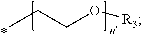
wherein the substituted C1-C6 alkyl group is substituted with a cyano group, an amino group, a monoalkylamino group, or a dialkylamino group; the alkyl is a C1-C3 alkyl;
R3 is hydrogen or a C1-C6 alkyl group; and
n′ is an integer from 1 to 30; 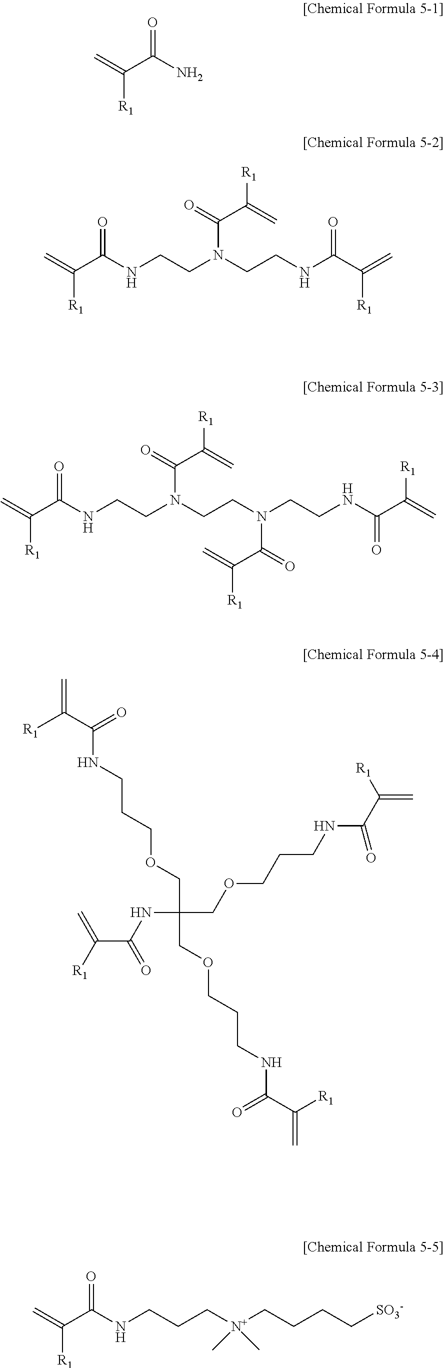 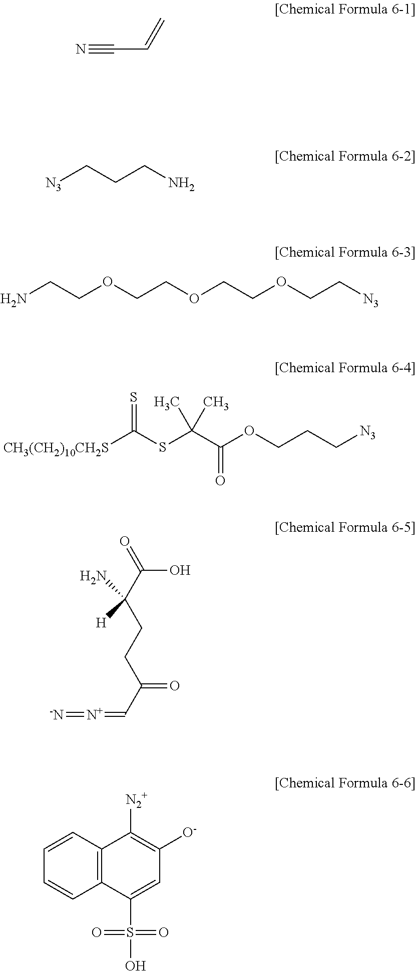
in Chemical Formulas 5-1 to 5-5, R1 is hydrogen or a C1-C6 alkyl group.

3. The polymeric interlayer according to claim 1, wherein the monomer is in a liquid state.

4. The polymeric interlayer according to claim 1, wherein the molal concentration of the lithium salt in the solvent of the lithium-solvent complex is 0.1-30 m.

5. The polymeric interlayer according to claim 1, wherein the weight ratio of the liquid solvent to the monomer is 60-99:1-40.

6. The polymeric interlayer according to claim 1, wherein the polymeric interlayer further comprises an additive, and the additive is one or more selected from metal or metalloid nitrides, nitrogen-containing salts of alkali or alkaline earth metals, halide-based additives, oxide-based additives, sulfide-based electrolyte additives, borohydride-based electrolyte additives, metal boron compounds, and carbon-based property improvement additives.

7. The polymeric interlayer according to claim 6, wherein the additive is 1-20 parts by weight based on 100 parts by weight of the sum of the monomer and the lithium-solvent complex.

8. The polymeric interlayer according to claim 6, wherein one or more diffraction spots are observed in the Fourier Transform (FFT) pattern corresponding to the cryogenic transmission electron microscopy (cryo-TEM) image of the polymeric interlayer.

9. The polymeric interlayer according to claim 8, wherein the diffraction spots are one or more selected from LiF nanocrystals, Li3N nanocrystals, and Li2O nanocrystals.

10. A battery comprising an anode, an electrolyte, and a polymeric interlayer formed at the interface between the anode and the electrolyte according to claim 1.

11. The battery according to claim 10, wherein the anode is lithium metal, and the electrolyte is a sulfide-based solid electrolyte.

12. A device comprising a battery according to claim 10, wherein the device is selected from communication devices, transportation devices, energy storage devices, home appliances, medical devices, robotic devices, aerospace devices, and military devices.
